(19) United States
(12) Patent Application Publication
(10) Pub. No.: US 2025/0315770 A1
(43) Pub. Date: Oct. 9, 2025

(54) PILOT AND INSTRUCTOR EXPERTISE

(71) Applicant: SLING PILOT ACADEMY, Torrance, CA (US)

(72) Inventors: Matthew Liknaitzky, Torrance, CA (US); Jean d'Assonville, Torrance, CA (US); Wayne Toddun, Torrance, CA (US)

(21) Appl. No.: 19/169,447

(22) Filed: Apr. 3, 2025

Related U.S. Application Data
(60) Provisional application No. 63/575,238, filed on Apr. 5, 2024.

(51) Int. Cl. G06Q 10/0639; G06Q 50/20; G09B 19/16

(52) U.S. Cl. CPC G06Q 10/06398; G06Q 50/20; G09B 19/165

(57) ABSTRACT

Training a flight instructor via actual flights with students by way of collecting data of a specific student and specific instructor then collecting the aircraft's flight metrics data during the same flight. Providing the server the data and providing weather data of the flight date including at least a Meteorological Aerodrome report (METAR) via a network in signal communication. The training server generates normalized values for each raw student performance metric to reflect one or more of the student experience, time of day, weather, and aircraft systems functional data; and, the training server is configured to use the normalized values and generate for the flight at least one of a numerical value for the specific one of a 1st, 2nd, 3rd, 4th and Nth student with 1st instructor performance a numerical value for the 1st instructor overall performance.

### BACKGROUND OF THE DISCLOSURE

This Non-Provisional Application claims the benefit of priority U.S. (U.S.) Provisional Patent Application Ser. No.: 63/575,238, filed Apr. 5, 2024, and entitled “IMPORIVING PILOT AND INSTRUCTOR EXPERTISE”, the disclosures of which are incorporated herein by reference in their entirety.

### BACKGROUND OF THE DISCLOSURE

### Field of the Disclosure

The present disclosure relates training pilots and instructors. Various embodiments of the present disclosure relate generally to systems and methods for training for aircraft operators and, more particularly, to systems and methods for providing and evaluating evidence-based training for aircraft operators.

### Related Art

In flying there are many variables. Even in basic training aircraft there is a wide spectrum of configurations above and beyond the basic analog six pack of instruments versus glass cockpit or Electronic Flight Displays (EFDs) commonly referred to as EFDs include flight displays such as primary flight displays (PFD) and multi-function displays (MFD). via digital instruments. A yoke, ½ yoke, or stick, also variations in positioning of switch and gauges in the cockpit which is even more pronounced in non-FAA certified light sports aircraft. Trim control, performance such as stall speed, best rate of climb, safe flap speed and never exceed speeds all vary. Further high wing versus low wing contribute to varied performance such as ground effect. Fuel injection versus carburation, turbo versus non turbo also adds to variation. Aircraft usage and hours on the airframe, the engine and the like all are variables.

Different instructors (CFI) will have their own “style” or strengths and weaknesses. However, the fundamental in flight education by instructors should consistently exceed a predetermined level. Further each student will have his or her own strengths and weaknesses and one instructor may be a better fit with one student than another. But, the end result should be a learning environment wherein the instructor effectively imparts knowledge to the student and the student retains such knowledge. It is common for one instructor to train multiple students. Working as an instructor is a common way for a pilot to accumulate sufficient hours to work as a commercial pilot.

In modern “glass cockpit” aircraft several multi-function displays (MFD) driven by flight management systems FMS which can be adjusted to display flight information as needed. Such displays include Primary Flight Display (PFD) & the Multi Function Display (MFD). An array of sensors, including but not limited to air data computers with input from static-pitot system and outside air temperature (OAT) sensors, attitude and heading reference system which may include accelerometers and magnetometers. GPS, autopilot systems and angle of attack indicators. Simulator which are ground based systems to teach are well known.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

Therefore it is a desideratum to have methods and systems that normalize teaching outcomes and performance of at least one of instructors (certified flight instructors “CFI”) and students.

### DESCRIPTION

To normalize objective metric measures necessary to compare results orient training, a positive gamification feedback is disclosed. Aircraft are normalized on a dynamic basis before, during and/or after each flight, having substantially the same aircraft deployed for each instructor and student. Any variation in said aircraft in a fleet are normalized via the collection of fleet data which is compared and valued to adjust for any anomalies between aircraft. Modern training aircraft have a number of flight systems, engine and balance of plant sensors and alarms for exceeding thresholds.

Real world actual flight training performance and measurements is direct evidence of competency of a student pilot and instructor combination. Safety in aircraft and flight is supported by a pilot maintaining a predetermined level of situation awareness and execution of primary flight functions while in the aircraft in the real world not in a simulator.

The end result should be a learning environment wherein the instructor effectively imparts knowledge to the student and the student retains such knowledge. It is common for one instructor to train multiple students. Working as an instructor is a common way for a pilot to accumulate sufficient hours to work as a commercial pilot. The method system disclosed herein includes but is not limited to identifying instructor short comings (and correcting them if possible) early one before such shortcomings are passed on to students. The method system disclosed herein includes but is not limited to identifying instructor effectiveness with a spectrum of students and adjusting pairings/schedule to pair students with instructors which are effective for specific students.

The method system disclosed herein includes but is not limited to identifying instructor and/or students whose performance is deviating below a predetermined level of knowledge and/or execution and mitigate such problems.

Performance measurements of students are an indicator of critical and/or key competencies instructor assets are tasked with teaching to students. Such competencies include but are not limited to safe, effective, and efficient actions in a flight environments. Normalized flight data is an indicator of machine asset performance (aircraft), instructor (people) asset performance, and student execution.

Disclosed herein are aspects of systems, methods to gamified performance measurements in actual flight (not simulation) for use in network based systems for predictive machine asset analysis and/or intervention, human asset training and/or intervention. In some instances recognition and/or reward for normalized results of excellence in safety, efficiency, and performance to meet criteria are populated through the network.

Disclosed herein are aspects of systems, methods of training a flight instructor via actual flights with students including collecting during a specific flight with a specific student, one of a 1st, 2nd, 3rd, 4th and Nth student's raw performance metrics data during a specific flight with a 1st instructor. Collecting the aircraft's flight metrics data during the same flight. Collecting the aircraft systems functional data during the same flights. Providing via a network in signal communication with the training server the collected data to a training server. Providing weather data of the specific flight date including at least a Meteorological Aerodrome report (METAR) via a network in signal communication with the training server. The training server generates normalized values for each raw student performance metric to reflect one or more of the student experience, time of day, weather, and aircraft systems functional data. The training server is configured to use the normalized values and generate for the flight at least one of: (a) a numerical value for the specific one of a 1st, 2nd, 3rd, 4th and Nth student with 1st instructor performance (b) a numerical value for the 1st instructor overall performance with the specific one of a 1st, 2nd, 3rd, 4th and Nth student (c) a competency report for the 1st instructor with the specific one of a 1st, 2nd, 3rd, 4th and Nth student.

In some instances a 2nd instructor different from 1st instructor and, the training server is configured to use the normalized values and generate for the flight at least one of (a) a numerical value for the specific one of a 1st, 2nd, 3rd, 4th and Nth student with 2nd instructor performance (b) a numerical value for the 2nd instructor overall performance with the specific one of a 1st, 2nd, 3rd, 4th and Nth student (c) a competency report for the 2nd instructor with the specific one of a 1st, 2nd, 3rd, 4th and Nth student and (d) generate an instructor (CFI) effectiveness rank (IER) value of 1st instructor and 2nd instructor with the specific one of a 1st, 2nd, 3rd, 4th and Nth student. In some instances the IER value for the 1st and the 2nd instructors with the specific one of a 1st, 2nd, 3rd, 4th and Nth student is updated after each flight.

In some instances the method comprising a 3rd instructor different from 1st and 2nd instructor and, the training server is configured to use the normalized values and generate for the flight at least one of (a) a numerical value for the specific one of a 1st, 2nd, 3rd, 4th and Nth student with 3rd instructor performance (b) a numerical value for the 3rd instructor overall performance with the specific one of a 1st, 2nd, 3rd, 4th and Nth student (c) a competency report for the 3rd instructor with the specific one of a 1st, 2nd, 3rd, 4th and Nth student and (d) generate an instructor effectiveness rank (IER) value of 1st, 2nd and 3rd instructor with the specific one of a 1st, 2nd, 3rd, 4th and Nth student. In some instances the IER value for the 1st, 2nd and 3rd instructors with the specific one of a 1st, 2nd, 3rd, 4th and Nth student is updated after each flight.

In some instance a 4th instructor different from 1st, 2nd and 3rd instructor and, the training server is configured to use the normalized values and generate for the flight at least one of: (a) a numerical value for the specific one of a 1st, 2nd, 3rd, 4th and Nth student with 4th instructor performance (b) a numerical value for the 4th instructor overall performance with the specific one of a 1st, 2nd, 3rd, 4th and Nth student. (c) a competency report for the 4th instructor with the specific one of a 1st, 2nd, 3rd, 4th and Nth student and (d) generate an instructor effectiveness rank (IER) value of 1st, 2nd, 3rd and 4th instructor with the specific one of a 1st, 2nd, 3rd, 4th and Nth student. In some instances the IER value for the 1st, 2nd, 3rd and 4th instructors with the specific one of a 1st, 2nd, 3rd, 4th and Nth student is updated after each flight.

In some instances the method includes using the normalized data of a 1st student from a plurality of instructors and rank each instructor on competency of instructing 1st student on each of the measured competency metrics.

In some instances the method further comprising using the normalized data of a 1st student from a plurality of instructors and rank each instructor on overall performance of instructing 1st student on the flight.

### FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIGS. 1 illustrates aspects of ground traffic activity at an airport and aircraft within the ground traffic.

FIG. 2 illustrates aspects of glide slope landing.

FIG. 3 illustrates aspects of air traffic air patterns.

FIG. 4 illustrates aspects of altitude target limits during flight.

FIG. 5 illustrates aspects of altitude deviations during flight.

FIGS. 6 and 7 illustrates aspects of course and deviations during flight.

FIG. 8 is a system block diagram of an example of an implementation of system for providing flight data collected during a specific flight to a network.

FIG. 9 is a system block diagram of aspects of an exemplary implementation of the one or more servers of the system of fleet management and instructor training.

FIG. 10 is a system block diagram of aspects of an exemplary implementation of a server of the one or more servers.

FIG. 11 is a flowchart is shown of an example of an implementation of a method utilized by the system shown in FIG. 9 of specific instructor effectiveness with a plurality of students in accordance with the disclosure.

FIG. 12 is a flowchart is shown of an example of an implementation of a method utilized by the system shown in FIG. 9 of specific instructor effectiveness with a population of instructors and of students in accordance with the disclosure.

FIG. 13 is a flowchart is shown of an example of an implementation of a method utilized by the system shown in FIG. 9 of specific instructor effectiveness versus other instructors with same student(s).

FIG. 14 is a table of student SIP values in accordance with aspects of the method utilized by the system shown in FIG. 9.

FIG. 15 aircraft data upload download also in air.

FIG. 16 aircraft data upload download on ground

All descriptions and callouts in the Figures and all content therein are hereby incorporated by this reference as if fully set forth herein.

### FURTHER DESCRIPTION

Disclosed herein are aspects of systems, methods to value assets, including but not limited to human assets (instructors) which are valued in a dynamic fashion and in some instances are used to construct and update an “Instructor Effectiveness Rank” (IER) for each human asset. The IER of normalized results based on actual inflight measurements rather than simulations is invaluable to, including but not limited to, identify progress and achievement or a need for remediation of a human asset instructor. The IER based on actual inflight measurements rather than simulations is invaluable to identify such important flight instructor skills, including but not limited to, mastery of specified knowledge, ability to teach, ability to problem solve in flight, adherence to rules and or regulations.

Student performance among a number of different instructors adds a human communication of knowledge and/or personality variable to the analysis. Each student enter flight school at some point on the beginner spectrum and each will have talents and deficits. Utilizing at least collected flight performance metrics in actual flight environments for each student with a group of Student-Instructor Pairings (SIP) student flight metrics quantifies at least an instructor effectiveness with a particular student and an instructor effectiveness with a group of students. SIP student flight performance metrics are utilized to identify instructor deficiencies, student performance levels with multiple instructors, instructor effectiveness over multiple students.

Situational awareness is fundamental to piloting. Situational awareness includes at least Environmental awareness, mode (configuration) awareness, aircraft system awareness, spatial orientation and time horizons. Performance and demonstration of situational awareness (at a pre-defined level) in flight, during actual not simulated conditions, is data collected by computing devices in the aircraft by our system and method for training at least one of a pilot and instructor.

Within situational awareness is environmental awareness which includes weather, air traffic control (ATC) communications and/or aircraft to aircraft communications, and terrain. Mode awareness is more and more important in modern glass cockpits and it includes, but it bot limited to, aircraft configuration and flight control systems (such as speed, altitude, heading, autopilot control and input, switching between modes). Spatial orientation is managing the physical position of the aircraft and its attitude. System awareness is addressing changes in the aircraft systems such as switching fuel tanks (for weight balance) and to maintain fuel flow, trim, throttle, manifold pressure etc. . . . a student should maintain a safe level on such system and adjust aircraft controls to accomplish same. Awareness of time is also critical and data collection of flight instruments, GPS, radio transmissions and the configuration of aircraft are records of same.

Voice recording systems (VRS) local to the aircraft can be used via keywords to demarcate specific performance intervals versus teaching intervals to reduce error of teaching activities which by intent of the instructor illustrate poor execution and remedies as opposed to actual student poor performance and poor execution can thereby be separated by training servers from the collected data.

Examples of teaching include but are not limited to teaching by CFI (certified Flight Instructor) of VOR (radio) navigation, slow flight, stalls, steep turns, standard rate turns. Examples of performance include but are not limited to student VOR (radio) navigation, slow flight, stalls, steep turns, standard rate turns. Our system is applicable to training aircraft which include, but are not limited to, digital instruments providing data feeds which can be stored in local databases during flight. The system include altimeter at least altimeters, tachometer, oil pressure, oil temperature, engine temperature, manifold pressure, airspeed indicator, vertical speed indicator, attitude indicator, heading indicator, turn coordinator and GPS Time, latitude, longitude, magnetic heading, GPS (altitude, time, date, ground speed, velocity, altitude, vertical airspeed speed, airspeed, pitch, roll, Lateral Acceleration (G), Acceleration (G), angle of attack (AOA) selected heading, selected altitude, barometer, communication frequency selected, second communication frequency selected, navigation frequency, outside air temperature (OAT), density altitude, height above ground, wind speed, wind direction, fuel, flaps, trim. Ideally autopilot information including but not limited to navigation distances, navigation course, navigation bearing.

In these performance intervals deviation from course and/or altitude set is measured and valued based on amount of deviation and scale of deviation. For example repeated (during a performance interval) ±5 degrees deviation may be set as an acceptable range if during the performance interval the student corrects back to course within a time gap rather than continues off course. However repeated ±5 degrees deviation without timely correction may be set as an unacceptable deviation. The quantity and time of course deviations during a performance interval are collected for analysis and scoring in the system. The automated flight display Similarly for altitude even repeated ±<50-foot deviation may be set as an acceptable range if during the performance interval the student corrects back to course within a time gap rather than continue off course. However repeated ±>100-foot deviation in altitude even with timely correction may be set as an unacceptable deviation. Moreover a single ±>150-foot deviation even with timely correction may be set as an unacceptable deviation. In these performance intervals deviation from a performance GPS such as glide slope, pattern altitude and configuration, ground movement and the like are all performance items which can be measured against a threshold regarding acceptable deviation and range of performance to be scored. Deviation beyond a threshold may be used for proficiency training for human assets (instructors) and students. Said threshold may be further normalized based on time, date, student hours flown, weather, and aircraft system variability.

Radio communication which can be monitored with local voice recorder and decisions can be scored. Radio protocol such interval between the time a student sets secondary frequencies for a next leg of journey for ATIS, ATC or traffic versus the time the pilot monitors or makes the secondary frequency primary compared to the specific location requiring such communications can be measured with GPS and time sensors and logs of radio channel choices and selection. Further whether instructor or student responds to ATC can be discerned and therefore measured to gauge student radio response operations.

Local voice recording are scraped for keywords by instructors (may be keyed to instructor side (right side) microphone input to add keywords in real time to demarcate a specific student performance interval to be scored. Further, microphone input to add keywords in real time to demarcate a specific instructor training interval to be omitted from student flight scoring.

The system can be configured whereby altitude and/or GPS location triggers data collection specific to certain aspects of flight. For example, location of an aircraft during taxi, on the runaway below a predetermined altitude and approaching or departing a runway within the geographic space and altitude of an airport pattern. Such systems provide insight into ground movement awareness and flight awareness of proximity to airspace which requires authorization to enter.

Local dashboard (dashcams) or positional cameras on fuselage, empennage, wings or and gear of the aircraft time stamped digital video or digital still photographs of aircraft movement and position at an airport, taxiway or runway can be acquired. Such image acquisition can be constant during movement of the aircraft on the ground (as indicated by at least one of altimeter and airspeed) or it can by switched on and off by the human instructor asset.

In flight collection of system and subsystem performance during use by a specific human asset (instructor) and/or by specific students is configured to normalize aircraft in a fleet to normalize difference known between the same model aircraft in the fleet. In some instances such machine asset collected data from a fleet of substantially similar aircraft shows anomalies which are below a threshold which would trigger a warning sensor from the onboard flight instruments and engine systems but which can impact student performance or skew student performance and therefore impact instructor effectiveness is not normalized.

In some instances machine asset data collected in real time may be used by fleet control to intervene in a predictive fashion before a machine asset fails or may become dangerous. In some instances machine asset data collected in real time may be used by fleet control to service or have a maintenance check on an aircraft in advance of regular required maintenance in a predictive fashion before a machine asset fails or may become dangerous.

Examples of teaching include but are not limited to teaching by CFI of VOR (radio) navigation, slow flight, stalls, steep turns, standard rate turns. Examples of performance include but are not limited to student VOR (radio) navigation, slow flight, stalls, steep turns, standard rate turns. Our system is applicable to training aircraft which include, but are not limited to, digital instruments providing data feeds which can be stored in local databases during flight. The system include altimeter at least altimeters, tachometer, oil pressure, oil temperature, engine temperature, manifold pressure, airspeed indicator, vertical speed indicator, attitude indicator, heading indicator, turn coordinator and GPS Time, latitude, longitude, magnetic heading, GPS (altitude, time, date, ground speed, velocity, altitude, vertical airspeed speed, airspeed, pitch, roll, Lateral Acceleration (G), Acceleration (G), angle of attack (AOA) selected heading, selected altitude, barometer, communication frequency selected, second communication frequency selected, navigation frequency, outside air temperature (OAT), density altitude, height above ground, wind speed, wind direction, fuel, flaps, trim. Ideally autopilot information including but not limited to navigation distances, navigation course, navigation bearing.

It is appreciated by those skilled in the art that the circuits, components, modules, and/or devices in this disclosure are described as being in “signal communication” with each other, where signal communication refers to any type of communication and/or connection between the circuits, components, modules, and/or devices that allows a circuit, component, module, and/or device to pass and/or receive signals and/or information from another circuit, component, module, and/or device. The communication and/or connection may be along any “signal path” between the circuits, components, modules, and/or devices that allows signals and/or information to pass from one circuit, component, module, and/or device to another and includes wireless or wired signal paths. The signal paths may be physical such as, for example, conductive wires, electromagnetic wave guides, attached and/or electromagnetic or mechanically coupled terminals, semi-conductive or dielectric materials or devices, or other similar physical connections or couplings. Additionally, signal paths may be non-physical such as free-space (in the case of electromagnetic propagation) or information paths through digital components where communication information is passed from one circuit, component, module, and/or device to another in varying digital formats without passing through a direct electromagnetic connection.

The computing devices/smart devices disclosed herein operate with memory and processors whereby code is executed during processes to transform data, the computing devices run on a processor (such as, for example, controller or other processor that is not shown) which may include a central processing unit (“CPU”), digital signal processor (“DSP”), application specific integrated circuit (“ASIC”), field programmable gate array (“FPGA”), microprocessor, etc. Alternatively, portions DCA devices may also be or include hardware devices such as logic circuitry, a CPU, a DSP, ASIC, FPGA, etc. and may include hardware and software capable of receiving and sending information.

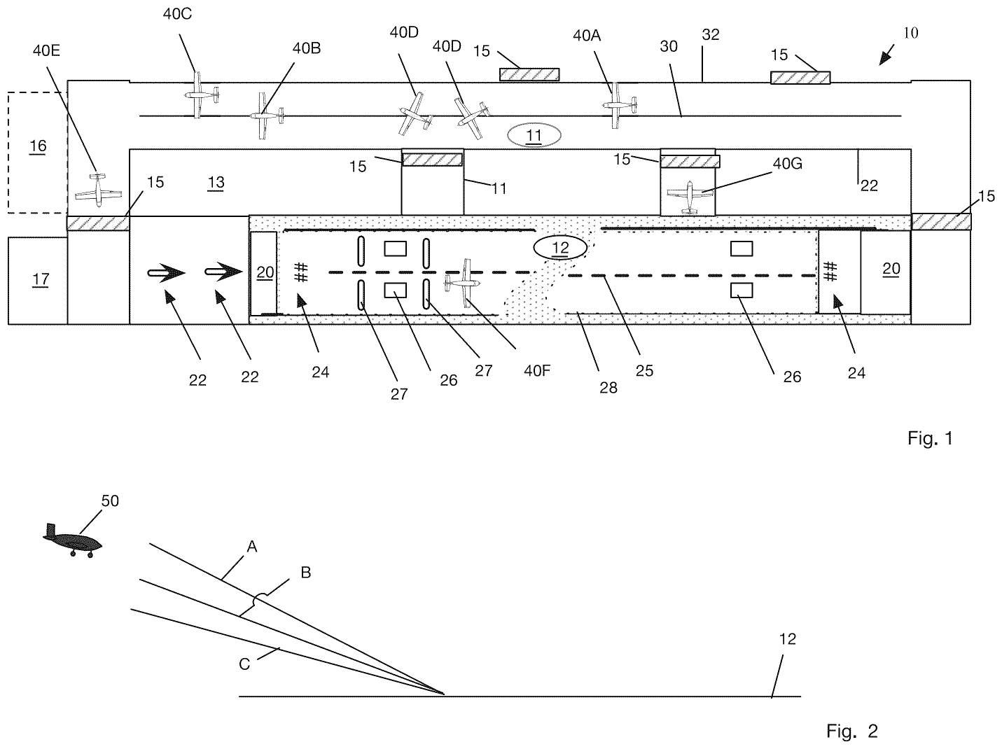

FIG. 1 illustrates an overview of an airfield (which includes airstrips and airports both towered and un-towered) with a runway 10. Taxiways 11 are fluidly connected to the runway 12 and separated by a runway safety area 13. Ground traffic movement onto taxiways, across taxiways and onto and off of runways is controlled by control taxiway control markers 15. Adjacent to taxiway are run-up areas 16 for preparation before takeoff. Additional areas around a runway include blast pads 17 which are not suitable for taxi, landing or take off. The runway visual threshold 20 is the start of the runway. In some instances displaced thresholds 22 will restricted a portion of a runway to only taxi and takeoff. Runway designators 24 are numerical indicators which identify the runway and the direction said runway faces. A runway center line 25 is provided for positioning. After runway designators aiming markings 26 are placed to give a distance from runway threshold indicator for pilots and other distance indicators 27 may also be present, the runway boundary 28 is also shown. Each taxiway has its own center line 30 for positioning the aircraft during taxi. Taxiways also have boundary markings 32 to provide areas that should not be crossed for safety to persons, property and the aircraft.

During ground procedures the position and movement of the aircraft is highly regulated to avoid collisions, damage to persons and property and for safety in general. Local dashcams or positional cameras can capture images during ground procedures. FIG. 1 illustrates a plurality of aircraft 40A-40G on the taxiway and runway. Each position of each aircraft provides an opportunity to measure a student performance metric. Non-limiting aspects of ground performance metrics “PM” include but are not limited position on a taxiway such as distance from the center line 30 and from boundary markings 32. Entering or exiting a taxiway or runways taxiway control markers 15, wait for clearance at appropriate taxiway movement control markers, entry and exit from run-up 16 area to runways 12 or back to taxiways 11. Movement prior to take off include proceeding past any restricted area blast areas 17 and runway safety areas 13. For example aircraft 40A has been maneuvered offset to the right of the taxiway center line 30 and almost crossing the boundary markings 32 which is not a preferred position and is scored lower than aircraft 40B which has been maneuvered on center line. However, aircraft 40B has been poorly maneuvered and allowed to cross the boundary markings 32 and that student and instructor is scored poorly and would require remedial education and/or alteration to teaching methodology for the instructor.

Aircraft 40D is shown in two positions as it is maneuvered swerving along the centerline 30. The swerving, depending on the distance and magnitude is be scored differently than the on center line taxi. Aircraft 40E is shown holding short at a taxiway control marker 15 and the position of the aircraft from the control marker can be measured and scored on proximity. Aircraft 40F is shown on landing or take off on the runway. In either case the student has ended up to the right of the runway center line 25 but within the runway boundary 28. If aircraft 40F was landing then the student's actual landing position from the aiming markings 26, for example, could be an additional data points collected as a Performance Metric “PM”. In such a case the instructor or student could use the local recorder to identify the landing target which can be measured against the actual landing via GPS, visual camera or other means. Aircraft 40G is shown holding short of a taxiway control marking. Ground movement of the aircraft during a training interval wherein the CFI (instructor) is training the student can be demarcated by a local voice recording of training interval with appropriate time stamp wherein and Performance Metris “PM” is not considered a student metric but rather can be separately analyzed as a CFI metrics “CM” which may have bearing on teaching knowledge, skill and method.

FIG. 2 shows and aircraft 50 on a glide slope indicated by line “B”. How the student maintains the glide slope or deviates above towards line “A” or below to line “C” are relevant performance metrics “PM”. Over time the student's PMs and the student instructor pairing (SIP) will show the trend of the student's PMs in each SIP this information is part of the training method and score system disclosed herein. Again if landings are during a training interval by identifying same as a training interval the metrics can be disregarded for the student performance but may be separately analyzed as CMs.

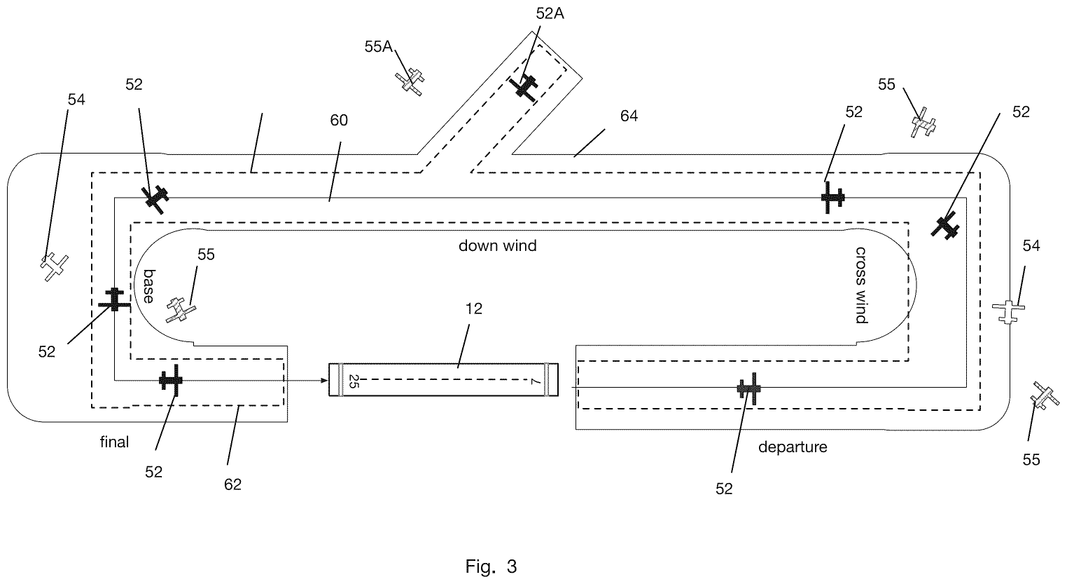

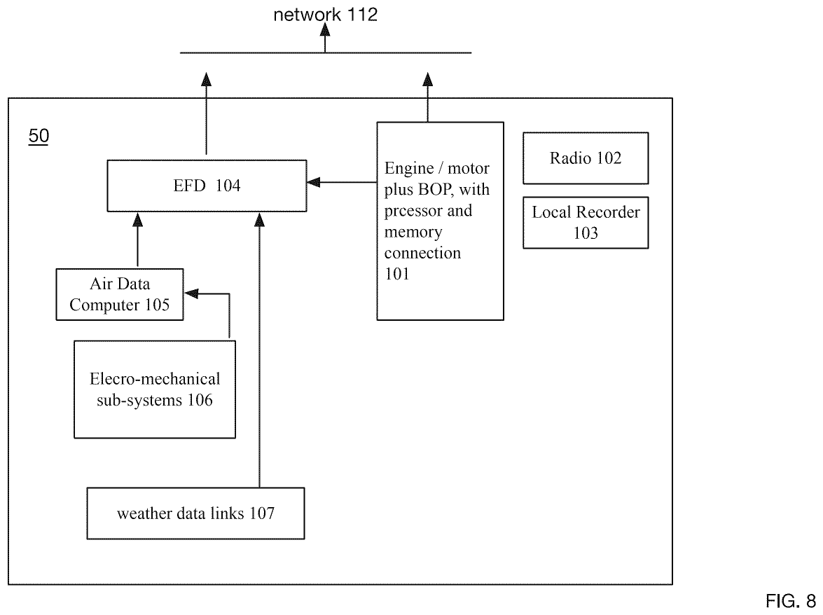

FIG. 3 illustrates aspects of a simplified airfield traffic pattern. flying in, entering and departing the pattern is a critical flight skill. Student pilot proficiency/skill in maneuvering within airfield pattern is critical to separation of aircraft and safety. Skills involved include adjusting attitude for wind, and managing altitude and flaps for controlled landing and controlled takeoff. Aircraft 52 is shown in a 2 dimensional view flying and operating within the ideal pattern 60. In the real world variation in position marked by line 62 will occur and the student will continue to be operating safety within the desired pattern, even further variation will occur within line 64. Our system collecting one or more of GPS, onboard instrument collection of data, local voice recording, and camera collects aircraft pattern information on position, speed, flap settings, altitude, glide slope, rate of decent or rate of climb on each flight with a SIP. Weather information and winds in particular including speed and direction are also provided to from Weather data and collected by the Training Module (see FIG. 8) with appropriate date and time stamp. Again if pattern work is during a training interval by identifying same as a training interval the metrics can be disregarded for the student performance but may be separately analyzed as CMs.

Aircraft 54 is shown within variations which have been identified as acceptable pattern positioning. Said variations may be dynamically changed based on weather and wind information. Aircraft 55 is shown outside all variations plotted at the time of aircraft 55 flight and in the scoring and training module the student (and instructor (CFI)) performance metrics “PM” for the aircraft 55 after normalization for certain defined variables including but not limited to weather, student experience and aircraft suboptimal flight system(s) flight will be scored lower than the performance metrics “PM” for aircraft 54 (also normalized) which will be scored lower than the performance metrics “PM” (also normalized) for aircraft 52. It is within the scope of this disclosure that a SIP may, during pattern practice, have times wherein the aircraft is within the ideal position illustrated by aircraft 52 and then in less desirable locations shown by aircraft 54 and also in undesirable locations shown by aircraft 55. Configuring the system to capture performance metrics “PM” at a sufficiently high sampling rate reduces false negative by allowing the student time to correct minor deviations. The system and methods set the sampling rate of position and assigns value to portions of the pattern wherein position and maneuvering into position based on an importance handicap thereby scaling the score. For example, the aircraft position, altitude, bank angle, speed during the turn from base to final will be scored higher than a cross wind to downwind turn wherein the pilot has greater time to adjust aircraft altitude, speed and position before the descent to landing. How each section of the pattern is scored can be fixed or variable when the Scoring Module assigns the raw value as a score. Varying the valuation of raw data to reflect risk portions of the pattern match real world needs to performance. In some instances the Training module and the Scoring Module may be combined into a single server and module.

Additionally, if Air Traffic Control (ATC) extends a leg of the approach or departure local voice recorders collect that information for appropriate normalization of the performance record for the student flight and the Training and Scoring Modules adjust for same.

When entering the pattern aircraft 52A is shown within the desired pattern entering the downwind leg, however aircraft 55A is far outside the desired pattern. In this instance the raw Performance Metric “PM” for the pilot (and CFI) of aircraft 55A will be valued lower than for the pilot (and CFI) of aircraft 52A.

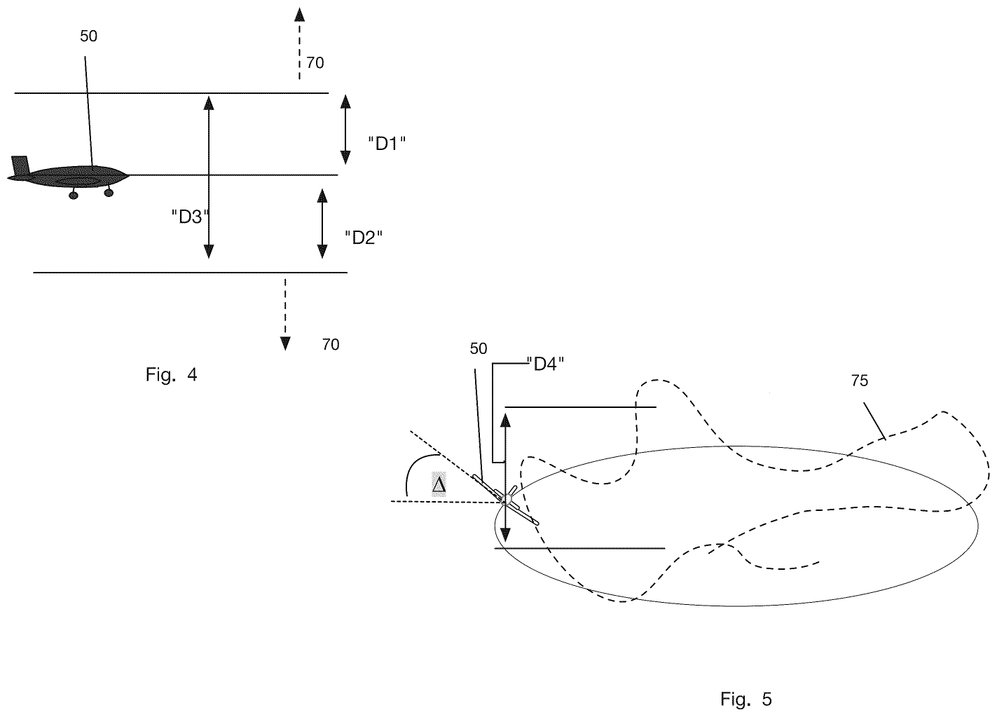

FIG. 4 illustrates an aircraft 50 flying level, the on board digital feed from flight instruments have the capacity to track vertical movement of the aircraft. For example an upward deviation of distance “D1” within a non-alarm range would have a higher Performance Metric “PM” raw value. However dropping below “D1” would equate to a lower raw value. Conversely in other instances a downward deviation of distance “D2” can be within a non-alarm range which would be valued higher. However falling below “D2 would equate to a lower value. A range of distance “D3” which allows for deviation both above and below level flight is similarly valued. Exceeding altitude variation along the line of arrow 70 above or below a limit (D3) will result in a lower raw value. Further consistent lower raw values (or normalized values) collected during sampling of student performance interval may be indicative of a CFI (human asset) shortcomings and/or an ineffective student instructor pairing (SIP).

FIG. 5 illustrates an aircraft 50 flying a steeply banked turn at a predetermined target bank angle of ±X degrees “Δ”. In a perfect execution the aircraft 50 both maintains the bank angle of ±X degrees “Δ” and maintains a level altitude or a level altitude with a “D4” variation range (see FIG. 4 discussion). In reality level flight may vary as shown by the line 75 and during sampling by the flight instrument collected data will show if the aircraft stayed within the level altitude variation. Valuation of the variation will be higher for less variation within “D4” distance and lower for outside of the “D4” variation.

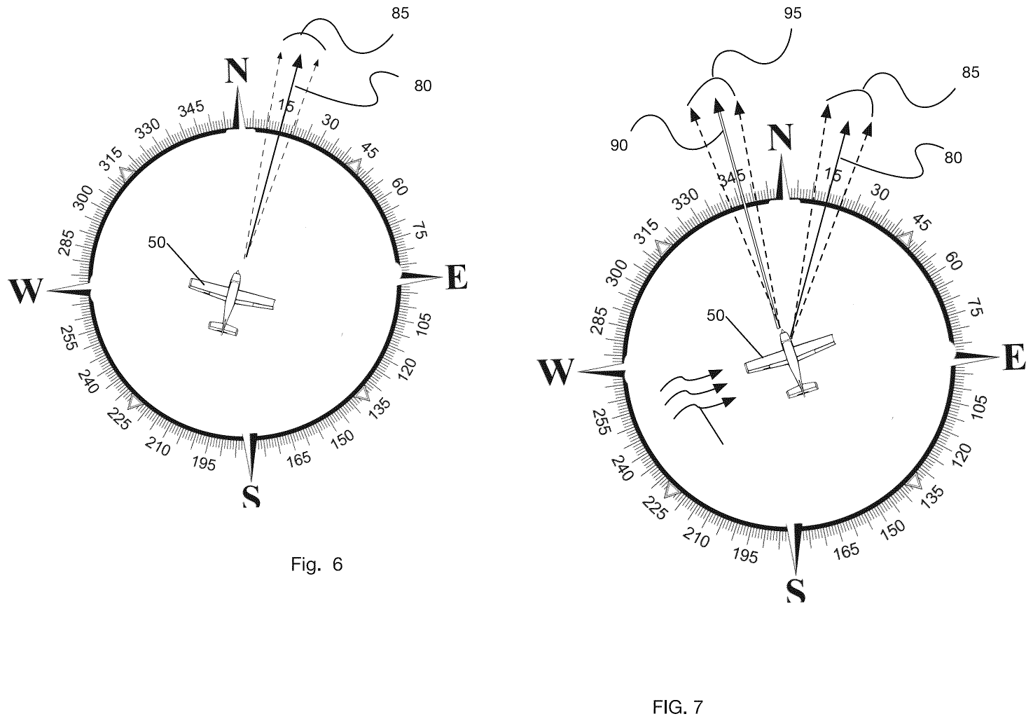

FIGS. 6 and 7 are two dimensional representations of navigation of an aircraft 50. The student pilot of aircraft 50 is tasked with following a course of “015” degrees, the on board digital feed from flight instruments have the capacity to track position of aircraft 50 on a course 80. FIG. 6 illustrates a selected plus-minus variation 85, which may be fixed or variable is utilized by the training module to score the student performance. During a sampling period the Performance Metric “PM” of the student's track along the heading is captured. The frequency and degree of variations from the course will impact the raw valuation. If, for winds and/or direction and speed of winds are outside a limit (or threshold) then the Scoring Module normalizes the student Performance Metric “PM” raw value to reflect the weather variable exceeding a threshold. FIG. 7 illustrates a selected plus-minus variation 85, which may be fixed or variable is utilized by the training module to score the student performance and a wind correction heading (direction the aircraft's nose is pointed) During a sampling period the training module can plot the student's heading 90 and progress or track along the desired course 80 and measure the quantity and degree of variation from the heading 95 or course 85. If variation exceeds a selected plus-minus variation values will be lower, the degree of variation outside of the selected range (85/95) and the frequency of such variation captured with sampling as a Performance Metric “PM” can then be averaged over time of the performance interval and used to value and score the student performance.

FIG. 8 shows aspects of a system overview of the flight system and method. Aircraft 50A-N collects metric data related to mechanical asset operation (flight systems generally) and human asset performance. The propulsion source (engine and/or motors) and the balance of plant (BOP) 101 (engine systems) supporting the propulsion source is in signal communications with at least a processor and said processor has memory whereby the propulsion source and BOP operation including but not limited to tachometer, oil pressure, oil temperature, engine temperature, manifold pressure, fuel quantity, fuel pressure, alternator output operational data is sampled over the course of a flight thereby collected over time in said memory for transmission through a network 112. A radio 102 also having at least one processor and memory is configured to be sampled over time to collect a record of usage, frequencies used, back-up frequency, monitored frequencies and the like. A local digital record 103 can optionally be included with time stamp to collect communications with ATC, and communication between Student and Instructor. Said communications can later be utilized by the system for at least keyword analysis. The electronic flight display (EFD) 104 also contains processor and memory. Said EFD is configured to receive inputs form an air data computer 105 which in turn receive inputs from electro mechanical sub-systems 106. Said inputs to the EFD are sampled over time and recorded. Weather data links 107 may also be supplied to the EFD. The data collected can include both raw Performance Metric “PM” such as selected RPM, airspeed, flap positioning, bank angel, angle of attack (AOA) during a specific flight with specific SIP combination during one or more performance intervals. The data collected includes the aircraft's flight metrics data during the same flight. The data collected includes the aircraft's systems functional data during the same flight.

The above non-exclusive list of data collection within aircraft 50A-N is configured to be in signal communication with and transmitted via a network 112.

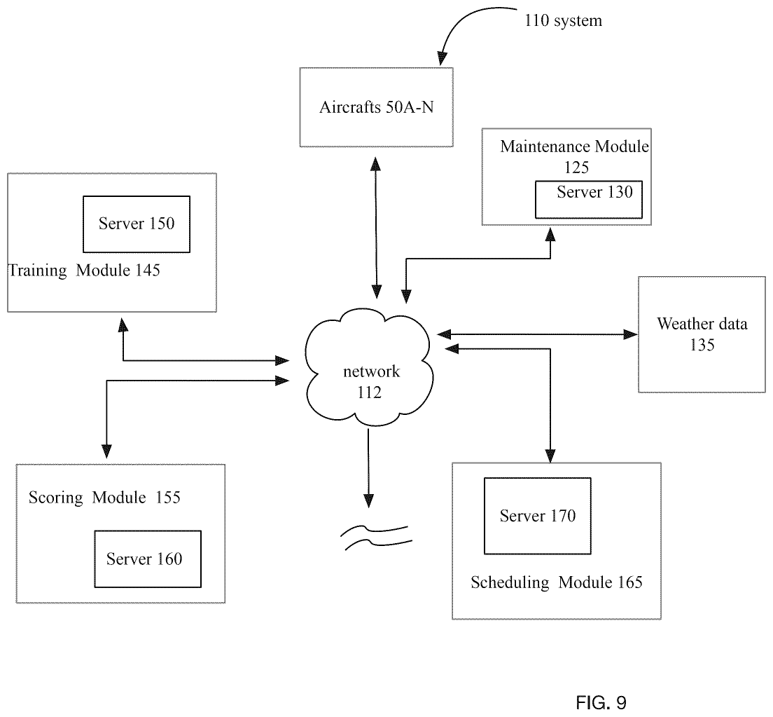

FIG. 9 is a block diagram of aspects of the flight training system 110 disclosed herein. The main modules are in signal communication with a network 112; main modules include the aircraft 50A-N which provide inputs, the Maintenance Module 125 and its server 130, Weather data 135, Training Module 145, and its server 150 Scoring Module 155 and its server 160 and Scheduling Module 165 and its server 170. Servers (150-170) may be the same server or separate servers and cach has one or more processors and they may be referred to interchangeably as the flight training system server(s). The network 112 may be any computer based network such as, for example, the Internet. The network may be one or more telecommunication networks that may include any type of wired and/or wireless network, including but not limited to local area networks (“LANs”), wide area networks (“WANs”), satellite networks, cable networks, Wi-Fi networks, WiMAX networks, mobile communications networks (e.g., 3G, 4G, 5G and so forth) or any combination thereof. The network 106 may utilize communications protocols, including packet-based and/or datagram-based protocols such as IP, transmission control protocol (“TCP”), user datagram protocol (“UDP”), or other types of protocols. Moreover, the network 112 may also include a number of devices that facilitate network communications and/or form a hardware basis for the networks, such as switches, routers, gateways, access points, firewalls, base stations, repeaters, backbone devices, and the like. In some examples, a server may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 902.11 standards (e.g., 902.11g, 902.11n, and so forth), and other standards. In this example, a server may be a personal computer, portable computer, server, etc. In general, the server 150 may include one or more computing devices that operate in a cluster or other grouped configuration to share resources, balance load, increase performance, provide fail-over support or redundancy, or for other purposes. For instance, the computing server may belong to a variety of classes of devices such as traditional server-type devices, desktop computer-type devices, and/or mobile-type devices. In some implementations, the server includes one or more input/output (“I/O”) interfaces that enable communications with input/output devices including peripheral input devices (e.g., a keyboard, a mouse, a pen, a voice input device, a touch input device, a gestural input device, and the like) and/or output devices including peripheral output devices (e.g., a display, a printer, audio speakers, a haptic output device, and the like). The server may also include a combination of two or more devices.

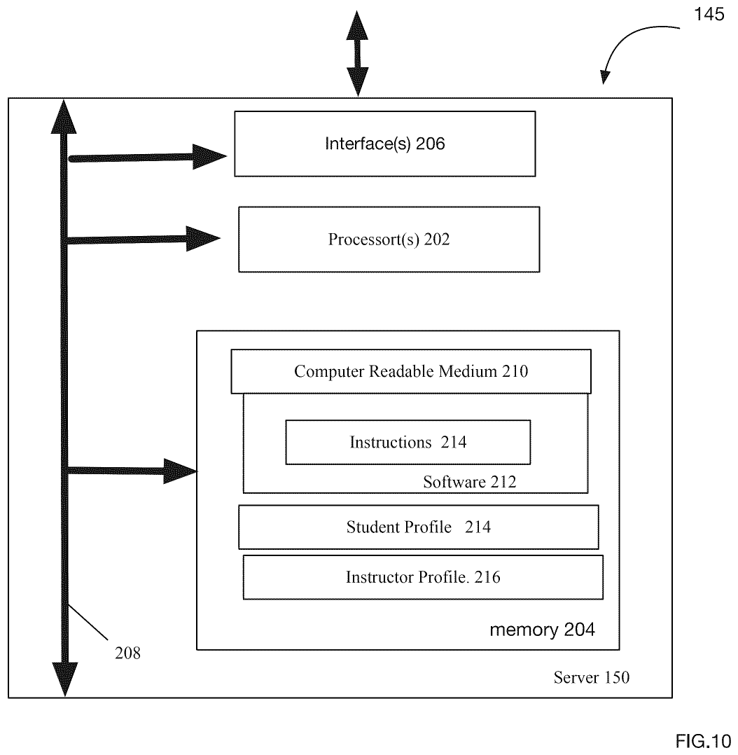

FIG. 10 is a system block diagram of an example of an implementation of the Training Module 145 in accordance with the present disclosure. The server 150 includes one and more processors 202, a memory 204, one or more interfaces 206, and a system bus 208. The memory 204 may include a computer readable medium 210 and software 212. The software 212 may include instructions 214 that are configured to control the one or more processors 202. In this example, the server 150 runs, maintains and updates the student, instructor and SIP captured metrics, in some instance the server normalizes one or more of the metrics based on variables which include but are not limited to flight hours, time, date, weather, other aspects of the aircraft flown that are both in the optimal range of operation and those that are below an alert or alarm threshold for maintenance but non-the-less based on predefined limits consider suboptimal acceptable range all of which may be run on the memory 204. The memory 204 may include one or more separate memory or storage devices that are configured to operate together. In this example, the system bus 208 is in signal communication with the one or more processors 202, the memory 204, and the one or more interfaces 206. In this example, the one or more interfaces 206 is in signal communication with the network 112.

The server 150 may represent any type of computing device having the one or more processing units 202 (also known as one or more processors) in signal communication to the computer-readable media 210 via the system bus 208, which in some instances may include one or more of a system bus, a data bus, an address bus, a PCI bus, a Mini-PCI bus, and any variety of local, peripheral, and/or independent buses. Executable instructions 214 stored on the computer-readable media 210 can include, for example, an operating system, a client communication module, a profile module, and other modules, programs, or applications that are loadable and executable by the one or more processing units.

The Training Module 145 receives inputs of weather data 135, information from maintenance module 125 on suboptimal functions on the aircraft flown, data from the aircraft 50 (as shown in FIG. 8). The Training Module access databases of collected data via a relational database management system (RDBMS). In some instance the Training Module will utilize key phrases, keywords or trigger word from a digital file captured and stored locally in the aircraft (prior to transmission) via the local record which records headset communications between student and CFI during operation. The key or trigger words are one way to separate training intervals from performance intervals, identify performance intervals and time sync them with flight system data. GPS location with or without keyword may be utilized to identifies intervals. Such GPS based intervals include but are not limited to ground movement, time in airfield pattern, glide slope, landing, maneuvers in designated practice areas and takeoff. Both keyword or trigger word and GPS may be utilized together to identify training versus performance intervals. Operations that can be consider in performance data scoring for at least one of CFI and student in a SIP include but are not limited to maintenance of a target altitude, following a course, correcting for wind on a course, following a VOR, changing course, rate of descent and ascent, navigation via instruments, navigation to visual waypoints

FIG. 11 is a system flow diagram is shown of the implementation of the method and system 300 showing greater detail in accordance with the present disclosure. In this example one instructor (also referred to as a CFI (certified flight instructor)) has his/her effectiveness analyzed across a plurality of students in student-instructor pairs (SIPS) to generate a normalized ranking for cach student with the CFI as well as valuing the CFI proficiency in teach such as below threshold, performing and excellent, each of those ranking categories can be further displayed in a spectrum of values within below threshold, performing and excellence. Aspects of main process steps include:
1. Collect Flight data from a specific aircraft for a specific flight with a specific SIP 302.
2. Normalize Flight data for any suboptimal variations in the aircraft 304. Suboptimal variations may include but are not limited to an aircraft that tends to be out of trim, an aircraft engine that runs hot, an aircraft seat that is partially reclined and cannot be straightened, and non-standard layout of switches. While these anomalies may be acceptable for safe flight they also are may either impact student performance and reduce student performance measurements. The system, when provided maintenance or aircraft module data on such suboptimal issues is able to adjust performance scores to be adjusted for the machine environment the SIP are flying.
3. Normalize Flight data for any weather condition above threshold 305. In addition to aircraft variation there will always be changing weather. On any given day or hour of day weather varies and such variation past a threshold level can and will impact performance on the SIP.
4. Next the method compares the specific student's normalized performance with other similarly experienced students when paired with the same CFI 306. Decisions on similar experience may be fixed based on flight hours, time of day, day or night, number of flights, number of landings, number of takeoffs, age, gender, height, weight and the like.
5. Based on said performance and normalization a ranking or placement for similarly experienced students, CFIs and SIPs based on values calculated for the plurality of student paired with the specific CFI is generated by the method 308. Said placement can be displayed transmitted an can change dynamically over time during a day, week or longer time frame.

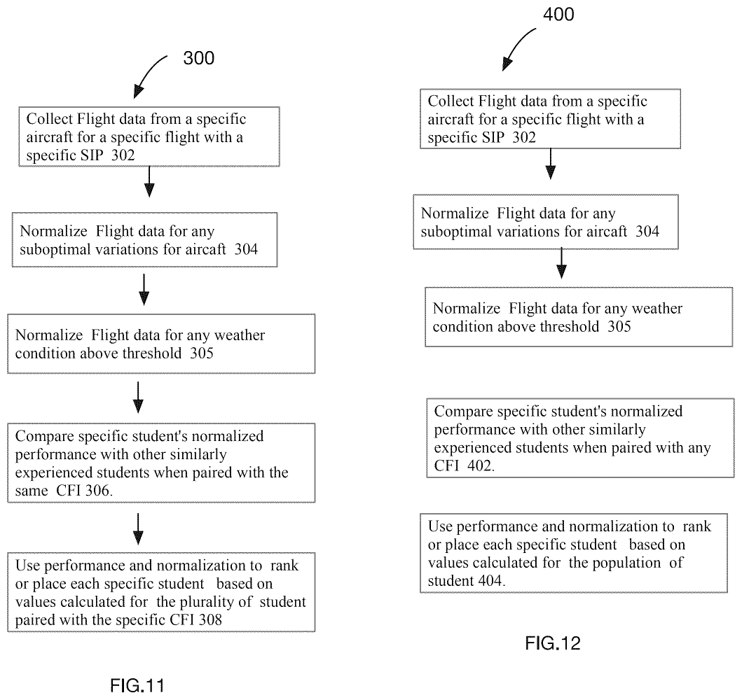

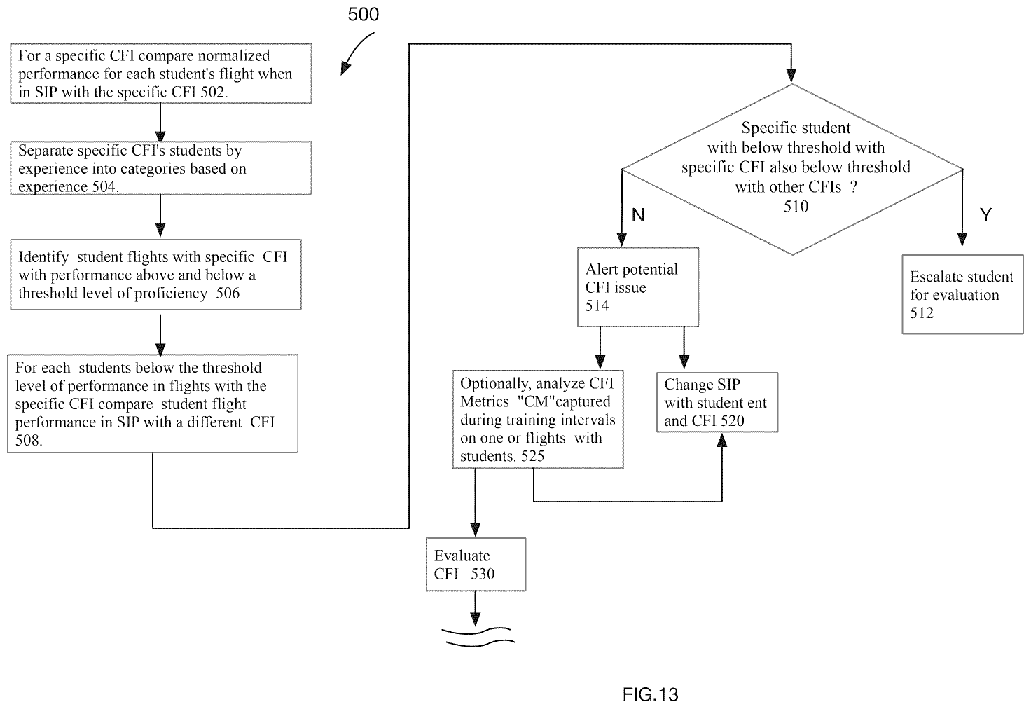

FIG. 12 is a system flow diagram is shown of the implementation of the method and system 300 showing greater detail in accordance with the present disclosure. In this example one instructor (also referred to as a CFI (certified flight instructor)) has his/her effectiveness analyzed across a plurality of students in student-instructor pairs (SIPS) to generate a normalized ranking for each student with the CFI as well as valuing the CFI proficiency in teach such as below threshold, performing and excellent, each of those ranking categories can be further displayed in a spectrum of values within below threshold, performing and excellence. Aspects of main process steps include:
1. Collect Flight data from a specific aircraft for a specific flight with a specific SIP 302.
2. Normalize Flight data for any suboptimal variations in the aircraft 304. The system, when provided maintenance or aircraft module data on such suboptimal issues is able to adjust performance scores to be adjusted for the machine environment the SIP are flying.
3. Normalize Flight data for any weather condition above threshold 305. In addition to aircraft variation there will always be changing weather. On any given day or hour of day weather varies and such variation past a threshold level can and will impact performance on the SIP.
4. Next the method compares the specific student's normalized performance with other similarly experienced students when paired with any CFI 402. Decisions on similar experience may be fixed based on flight hours, time of day, day or night, number of flights, number of landings, number of takeoffs, age, gender, height, weight and the like.
5. Based on said performance and normalization a ranking or placement for similarly experienced students, CFIs and SIPs based on values calculated for the plurality of student paired with all CFI is generated by the method 404. Said placement can be displayed transmitted an can change dynamically over time during a day, week or longer time frame.

FIG. 13 is a system flow diagram shows some aspects of the logic in training students, CFIs and creating SIPS. Aspects of main steps include:
1. For a specific CFI compare normalized performance for each student's flight when in SIP with the specific CFI 502.
2. Separate students by experience into categories based on experience 504. Experience can be a fixed set of criteria such as number of flights, number of landings, number of take-offs, number of hours flown etc. It may also be a variable criteria or unevenly weighted criteria for example giving greater value to landings than number of flights.
3. Identify student flights with specific CFI with performance above and below a threshold level of proficiency 506
4. For students below the threshold level of performance in flights with the specific CFI compare student flight performance in SIP with a different CFI 508.
5. Decide, does specific student with below threshold level performance with specific CFI also performance below threshold level with different CFI(s)? 510.
6A. If yes then escalate student for evaluation, possible retraining or repurposing 512.
6B. If no then send alert of potential CFI issue 515 and at least one of change SIP with student to different CFI 520 and retrain CFI 525

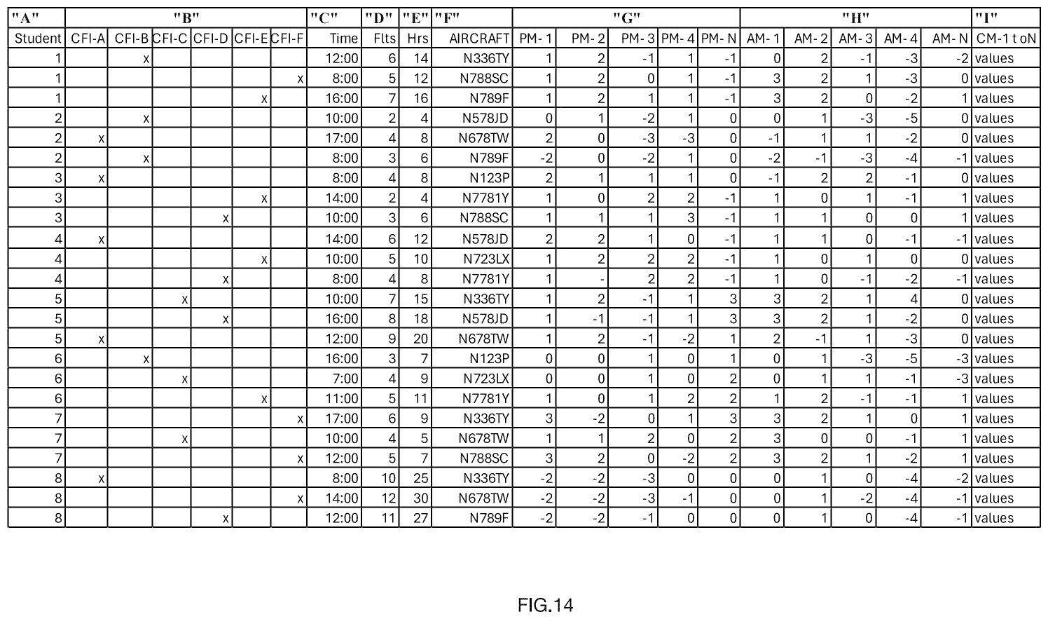

FIG. 14 is a table showing a record of a day of flights with students 1-8 listed in column “A”. The students have had different pairings with CFIs AA-FF shown in column “B”. The times of each flight is shown in Column “C”. The students total number of flight is shown in column “D” and the students total time piloting is shown in column “E”. The aircraft (machine assets) flown in each SIP are identified in column “F”. The performance metrics “PM” during performance intervals of the each student in each SIP is shown in column “G”, in this illustration raw data without normalization applied by the system software is displayed. Aircraft metric collected are shown in column “H” and for purposes of at least one of standardizing teaching, evaluating, ranking, certifying, training and retraining CFI's the CFI metrics “CM” during training intervals with students are collected displayed in Column “I”. CFI metrics “CM” are real world data of the activity of the CFI when teaching. This data is important for a variety of reasons, some of which include whether CFI violates (or does not correct student violations) of flight school minimum standards when in a training interval, whether CFI violates (or allows student to violate) any FAA rules such as airspace restrictions, whether CFI training is in a location, or at an altitude with unacceptable risk.

Aircraft metrics “AM”, measure during aircraft operation can be parsed into training versus performance intervals. However, the CFI in the end has responsibility even during both training and performance intervals to avoid damage to aircraft systems by operating in the “red” zone, beyond warning but into the alert region and such overall metrics are useful to asses CFI effectiveness and excellence or lack thereof. These aircraft metrics show operational decisions by cach SIP. For example periods of low rpm or high rpm can be damaging on the engine. Periods of high heat of engine or oil can be damaging on engine. Flying with low oil temperature or pressure can be dangerous and damaging the engine. In other instances

However, as CFIs will have different teaching, knowledge and communication skill sets with some exceeding all threshold of excellence, and others falling short on the excellence scale. Therefore it is important to further analyze specific students with a plurality of CFIs and the report of student performance in each SIP is utilized to normalize results, rank students, rank CFI effectiveness and identify risk.

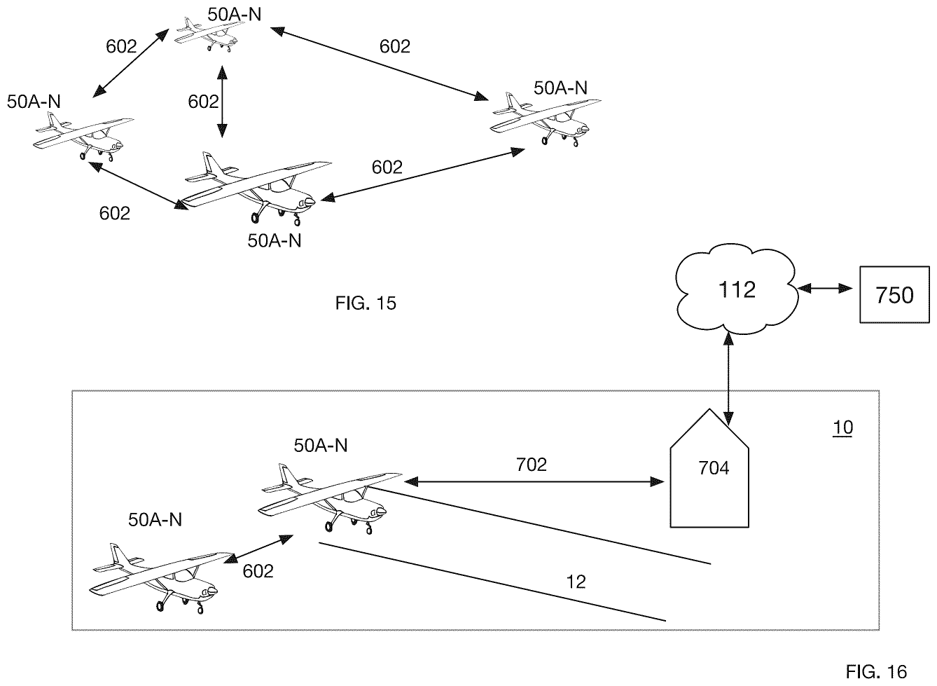

FIGS. 15-16 are a pictorial of fleet aircraft 50A-N. A sufficiently large fleet in some instances can be seen as a mobile network or nodes in a network whereby aircraft to aircraft data transfer and communication 602 can occur via WIFI, LTE,4G, 5G and so one and/or via satellite. Once at an airfield 10 aircraft 50A-N can then deliver a packet of data from at least one of its flight data system and data transmitted to it from one or more other fleet members flight system(s) to fleet management system 750. When at an airfield 10 transmission 702 to a ground source 704 with wired internet connectivity is accomplished by either wireless (near field, WIFI, LTE, 4G, 5G and satellite) or via wired connection. Said ground source can then transmit via a network 112 to the fleet management system 750. Said ground source in two way communication with said fleet management system can also transmit to the aircraft 50A-N data and instructions related to one or more of immediate corrective actions, immediate maintenance actions, predictive maintenance actions any of which may change the flight plan of the aircraft or the scheduling of the aircraft.

It will be understood that various aspects or details of the disclosures may be changed combined, or removed without departing from the scope of the invention. It is not exhaustive and does not limit the claimed inventions to the precise form disclosed. Furthermore, the foregoing description is for the purpose of illustration only, and not for the purpose of limitation. Modifications and variations are possible in light of the above description or may be acquired from practicing the invention. The claims and their equivalents define the scope of the invention.

What is claimed is:

1. A method of training a flight instructor via actual flights with students, the method comprising:
collecting during a specific flight with a specific student, one of a 1st, 2nd, 3rd, 4th and Nth student's raw performance metrics data during a specific flight with a 1st instructor;
collecting the aircraft's flight metrics data during the same flight;
collecting the aircraft systems functional data during the same flight;
providing via a network in signal communication with the training server the collected data to a training server;
providing weather data of the specific flight date including at least a Meteorological Aerodrome report (METAR) via a network in signal communication with the training server;
the training server generates normalized values for each raw student performance metric to reflect one or more of the student experience, time of day, weather, and aircraft systems functional data;
and, the training server is configured to use the normalized values and generate for the flight at least one of
a numerical value for the specific one of a 1st, 2nd, 3rd, 4th and Nth student with 1st instructor performance;
a numerical value for the 1st instructor overall performance with the specific one of a 1st, 2nd, 3rd, 4th and Nth student;
a competency report for the 1st instructor with the specific one of a 1st, 2nd, 3rd, 4th and Nth student.

2. The method of training a flight instructor via actual flights with students of claim 1 the method comprising a 2nd instructor different from 1st instructor and, the training server is configured to use the normalized values and generate for the flight at least one of;
a numerical value for the specific one of a 1st, 2nd, 3rd, 4th and Nth student with 2nd instructor performance;
a numerical value for the 2nd instructor overall performance with the specific one of a 1st, 2nd, 3rd, 4th and Nth student;
a competency report for the 2nd instructor with the specific one of a 1st, 2nd, 3rd, 4th and Nth student; and,
generate an instructor effectiveness rank (IER) value of 1st instructor and 2nd instructor with the specific one of a 1st, 2nd, 3rd, 4th and Nth student.

3. The method of training a flight instructor via actual flights with students of claim 2 wherein the IER value for the 1st and the 2nd instructors with the specific one of a 1st, 2nd, 3rd, 4th and Nth student is updated after each flight.

4. The method of training a flight instructor via actual flights with students of claim 2 the method comprising a 3rd instructor different from 1st and 2nd instructor and, the training server is configured to use the normalized values and generate for the flight at least one of;
a numerical value for the specific one of a 1st, 2nd, 3rd, 4th and Nth student with 3rd instructor performance;
a numerical value for the 3rd instructor overall performance with the specific one of a 1st, 2nd, 3rd, 4th and Nth student;
a competency report for the 3rd instructor with the specific one of a 1st, 2nd, 3rd, 4th and Nth student.
generate an instructor effectiveness rank (IER) value of 1st, 2nd and 3rd instructor with the specific one of a 1st, 2nd, 3rd, 4th and Nth student.

5. The method of training a flight instructor via actual flights with students of claim 4 wherein the IER value for the 1st, 2nd and 3rd instructors with the specific one of a 1st, 2nd, 3rd, 4th and Nth student is updated after each flight.

6. The method of training a flight instructor via actual flights with students of claim 4 the method comprising a 4th instructor different from 1st, 2nd and 3rd instructor and, the training server is configured to use the normalized values and generate for the flight at least one of;
a numerical value for the specific one of a 1st, 2nd, 3rd, 4th and Nth student with 4th instructor performance;
a numerical value for the 4th instructor overall performance with the specific one of a 1st, 2nd, 3rd, 4th and Nth student;
a competency report for the 4th instructor with the specific one of a 1st, 2nd, 3rd, 4th and Nth student.
generate an instructor effectiveness rank (IER) value of 1st, 2nd, 3rd and 4th instructor with the specific one of a 1st, 2nd, 3rd, 4th and Nth student.

7. The method of training a flight instructor via actual flights with students of claim 4 wherein the IER value for the 1st, 2nd, 3rd and 4th instructors with the specific one of a 1st, 2nd, 3rd, 4th and Nth student is updated after each flight.

8. The method of training a flight instructor via actual flights with students of claim 6, the method further comprising using the normalized data of a 1st student from a plurality of instructors and rank each instructor on competency of instructing 1st student on each of the measured competency metrics.

9. The method of training a flight instructor via actual flights with students of claim 6, the method further comprising using the normalized data of a 1st student from a plurality of instructors and rank each instructor on overall performance of instructing 1st student on the flight.
